(19) United States
(12) Patent Application Publication
(10) Pub. No.: US 2026/0318597 A1
(43) Pub. Date: Oct. 15, 2026

(54) DRYING DEVICE WITH STABLE CONVEYANCE

(71) Applicant: SUZHOU NSINGLE INTELLIGENT TECHNOLOGY CO., LTD., Suzhou (CN)

(72) Inventors: Hui WANG, Suzhou (CN); Jianhui TAN, Suzhou (CN); Xiangrong DAI, Suzhou (CN); Xingchi LIU, Suzhou (CN)

(21) Appl. No.: 19/317,973

(22) Filed: Sep. 3, 2025

Related U.S. Application Data
(63) Continuation of application No. PCT/CN2025/079753, filed on Feb. 28, 2025.

(30) Foreign Application Priority Data
Aug. 23, 2024 (CN) 202411166737.0

(51) Int. Cl. F26B 15/14; F26B 25/00; F26B 25/18; F26B 21/00; F26B 21/25

(52) U.S. Cl. CPC F26B 15/146; F26B 25/003; F26B 25/18; F26B 21/001; F26B 21/25

(57) ABSTRACT

The invention provides a drying device with stable conveyance, including at least one drying furnace disposed side by side. Each drying furnace includes: a furnace body, provided with a product channel, where one end of the product channel is a product inlet, and the other end of the product channel is a product outlet; a conveyance mechanism, used for conveying a product in the product channel, where the conveyance mechanism extends through the product channel, and is provided with a carrier for loading the product; a locking mechanism, arranged on the conveyance mechanism, and including a plurality of locking portions arranged on the conveyance mechanism in a product conveyance direction, where the locking portions are used for locking the carrier on the conveyance mechanism; and an unlocking mechanism, at least arranged at the product outlet, and used for releasing the locking of the carrier by the locking mechanism.

This application is a Continuation Application of PCT/CN2025/079753, filed on Feb. 28, 2025, which claims priority to Chinese Patent Application No. 202411166737.0, filed on Aug. 23, 2024, which is incorporated by reference for all purposes as if fully set forth herein.

### FIELD OF THE INVENTION

The present invention relates to the field of solar cell production technologies, and in particular, to a drying device with stable conveyance.

### DESCRIPTION OF THE RELATED ART

In the field of solar silicon wafer manufacturing, the drying of solar cells is one of the most critical steps, and a cassette-type drying furnace is a key device for completing the drying step. Typically, the cassette-type drying furnace includes a drying chamber formed by multiple drying modules. Carriers (e.g., cassettes or wafer boats) loaded with solar cells are conveyed through the drying chamber via a conveyance device. However, since the carriers are usually placed directly on the conveyance device, the carriers are prone to tilting and vibration during conveyance. This can cause the solar cells on the carriers to displace from their designated positions, leading to detachment or even breakage.

### SUMMARY OF THE INVENTION

To overcome the foregoing disadvantages, an objective of the present invention is to provide a drying device with stable conveyance, to improve the stability of a carrier in a conveyance process by locking the carrier, thereby effectively reducing the risk of detachment or breakage of a solar cell in a conveyance process.

To achieve the foregoing objective, the technical solution adopted in the present invention is a drying device with stable conveyance, including at least one drying furnace disposed side by side. Each drying furnace includes:
a furnace body, provided with a product channel, where one end of the product channel is and product inlet, and the other end of the product channel is a product outlet;
a conveyance mechanism, used for conveying a product in the product channel, where the conveyance mechanism extends through the product channel, and is provided with a carrier for loading the product;
a locking mechanism, arranged on the conveyance mechanism, and including a plurality of locking portions arranged on the conveyance mechanism in a product conveyance direction, where the locking portions are used for locking the carrier on the conveyance mechanism; and
an unlocking mechanism, at least arranged at the product outlet, and used for releasing the locking of the carrier by the locking mechanism.

The beneficial effects of the drying device of the present invention are as follows:

In the process of conveying the carrier loaded with the product along with the conveyance mechanism along the product channel, the carrier can be locked on the conveyance mechanism through the locking portions of the locking mechanism, to improve the stability of the carrier on the conveyance mechanism, thereby suppressing tilting or vibration of the carrier in the conveyance process. The unlocking mechanism is disposed at the product outlet to release the locking between the carrier and the conveyance mechanism, thereby facilitating the removal of the carrier from the conveyance mechanism.

Further, each of the locking portions includes locking assemblies symmetrically disposed on two sides of the carrier in a direction perpendicular to the product conveyance direction, each of the locking assemblies includes a locking block, an elastic member, and a movable member, the movable member is movable toward or away from the carrier along the conveyance mechanism, and the locking block is connected to a side of the movable member that faces the carrier; the elastic member is located at an end of the locking block that is away from the carrier, one end of the elastic member abuts against the locking block, and the other end of the elastic member is fixed on the conveyance mechanism; and when the locking block abuts against the carrier, the elastic member is in a compressed state.

Through the movement of the movable members of the two locking assemblies, the two locking blocks can be simultaneously driven to move toward or away from the carrier, thereby achieving the locking or unlocking of the carrier. The elastic members in a compressed state are then disposed to enable the locking blocks to elastically press against the carrier, thereby ensuring the locking of the carrier and avoiding damage to the surface of the carrier due to rigid pressing.

Further, the locking assembly further includes a mounting base, and the mounting base is fixedly connected to the conveyance mechanism, and a guide slot is opened on the mounting base and extends through the mounting base ; the movable member includes a pull rod passing through the guide slot, and an end of the pull rod that faces the carrier is connected to the locking block. The mounting base and the guide slot are disposed to guide the movement direction of the pull rod, thereby ensuring the accuracy of the locking direction of the locking block.

Further, the elastic member includes a spring sleeved over the pull rod, one end of the spring abuts against the locking block, and the other end of the spring abuts against the mounting base. Because the mounting base is fixedly connected to the conveyance mechanism, when an external force pulls the pull rod to move away from the carrier, the locking block can move synchronously, thereby compressing the spring. When the external force is removed, the locking block can move toward the carrier under the reset action of the spring.

Further, an obround slot in communication with the guide slot is opened on an upper end of the mounting base; and a vertical rod is fixedly disposed on the pull rod, and the vertical rod can pass through the obround slot. The obround slot is provided to limit the movement range of the vertical rod, thereby indirectly limiting the movement range of the pull rod.

Further, a locking protrusion is provided on a side of the locking block that faces the carrier; when the locking block abuts against the carrier, a lower end surface of the locking protrusion also abuts against the carrier; and the lower end surface of the locking protrusion is configured as a downward-arching arc-shaped surface. The locking protrusions are disposed to cooperate with the locking blocks to abut against the carrier at multiple positions and in different directions, thereby enhancing the locking stability of the carrier. In addition, the lower end surface of the locking protrusion is confiugred as the downward-arching arc-shaped surface to enable the contact between the locking protrusion and the carrier to be line contact, thereby minimizing the friction between the locking protrusion and the carrier.

Further, the unlocking mechanism includes unlocking assemblies symmetrically disposed on the conveyance mechanism in the direction perpendicular to the product conveyance direction, each of the unlocking assemblies includes a plate body arranged in the product conveyance direction, the plate body is suspended above the conveyance mechanism, and an unlocking surface capable of pressing against the movable member is provided on a side of the plate body that is away from the carrier; and when the carrier moves to the unlocking mechanism, the movable member is movable away from the carrier under the action of an unlocking surface, to disengage the locking block from the carrier. Through the limiting and abutting of the unlocking surface, the movable member can be forced to move away from the carrier, to disengage the locking block from the carrier, thereby achieving the unlocking of the carrier.

Further, the unlocking surface includes an unlocking inclined surface and a pressing flat surface that are continuously disposed in the product conveyance direction, the unlocking inclined surface gradually tilts away from the carrier from an end that is far away from the pressing flat surface to an end that is close to the pressing flat surface, to enable the vertical rod to drive the locking block to move away from the carrier when the vertical rod moves along the unlocking inclined surface toward a pressing flat surface. The unlocking inclined surface is disposed, so that when the movable member moves to the unlocking inclined surface along with the conveyance mechanism, the movable member can move away from the carrier along the unlocking inclined surface, thereby achieving the unlocking of the carrier from the locking block. When the movable member enters the pressing flat surface along the unlocking inclined surface, due to the pressing and limiting of the movable member by the pressing flat surface, the locking block remains in a state of being unlocked from the carrier, thereby ensuring that when the carrier moves to the pressing flat surface, the carrier can be removed from the conveyance mechanism.

Further, an end of the plate body that is away from the unlocking inclined surface is bent downward to form a bent plate, a guide surface is provided on a side of the bent plate that is away from the carrier, the guide surface includes a guide flat surface and a guide inclined surface that are continuously arranged; and the guide flat surface is located between the guide inclined surface and the pressing flat surface, the guide flat surface and the pressing flat surface are located in a same plane, and the guide inclined surface gradually tilts toward the carrier from an end that is close to the guide flat surface to an end that is far away from the guide flat surface.

When the vertical rod moves toward the bent plate along the plate body, the vertical rod can sequentially enter the guide flat surface and the guide inclined surface along the pressing flat surface, and when the vertical rod is pressed against the guide inclined surface, under the reset action of the spring and the guide action of the guide inclined surface, the locking block can gradually move toward the carrier, thereby buffering the reset action of the locking assembly.

Further, the furnace body is provided with a drying zone and a cooling zone in sequence in the product conveyance direction, a heating module used for heating the product channel is provided in the drying zone, and the heating module is a single-pass heating module or a dual-cycle heating module. The heating module is disposed to heat and dry the product in the product channel.

Further, a carrier recirculation mechanism used for conveying the carrier is provided below the furnace body, and a lifting mechanism used for lifting the carrier onto the conveyance mechanism is provided between the product conveyance mechanism that is close to the product inlet and the carrier recirculation mechanism.

When the product enters a next process stage from the product outlet, the carrier recirculation mechanism is disposed to enable the carrier at the product outlet to recirculate to the product inlet, and then the lifting mechanism lifts the carrier on the carrier recirculation mechanism onto the product conveyance mechanism, thereby facilitating the loading of a next product.

Preferably, the plate body is magnetic, a magnet is connected to an end of the pull rod that is close to the plate body, and the plate body can attract the magnet.

### BRIEF DESCRIPTION OF THE DRAWINGS

FIG. 1 is a three-dimensional schematic structural diagram of a drying device according to an embodiment of the present invention;

FIG. 2 is a partial enlarged view of a part A in FIG. 1;

FIG. 3 is a schematic structural diagram of a conveyance mechanism according to an embodiment of the present invention;

FIG. 4 is a schematic structural diagram of an unlocking mechanism acting on a locking mechanism according to an embodiment of the present invention;

FIG. 5 is a partial enlarged view of a part B in FIG. 4;

FIG. 6 is a schematic structural diagram of a furnace body according to an embodiment of the present invention;

FIG. 7 is a partial enlarged view of a part C in FIG. 6; and

FIG. 8 is a schematic structural diagram of another embodiment of the locking assembly.

FIG. 9 is a partial enlarged view of a part D in FIG. 1.

In the drawings:

1-furnace body; 11-product channel;

2-conveyance mechanism; 21-conveyance rack; 2-closed-loop chain; 23-support plate; 24-conveyance drive assembly;

3-locking mechanism; 31-locking block; 311-locking protrusion; 32-elastic member; 33-movable member; 331-pull rod; 332-vertical rod; 333-magnet; 3321-protective cover; 34-mounting base; 341-obround slot;

4-unlocking mechanism; 41-plate body; 411-unlocking inclined surface; 412-pressing flat surface; 42-bent plate; 421-guide inclined surface;

5-carrier;

6-heating module; 61-heating chamber; 62-circulating fan; and

7-carrier recirculation mechanism; 71-carrier rack; 72-linear conveyance module.

### DETAILED DESCRIPTION OF THE PREFERRED EMBODIMENTS

The preferred embodiments of the present invention are described below in detail with reference to the accompanying drawings, so that the advantages and features of the present invention may be more readily understood by those skilled in the art, thereby defining the scope of protection of the present invention more clearly and explicitly.

### Embodiment

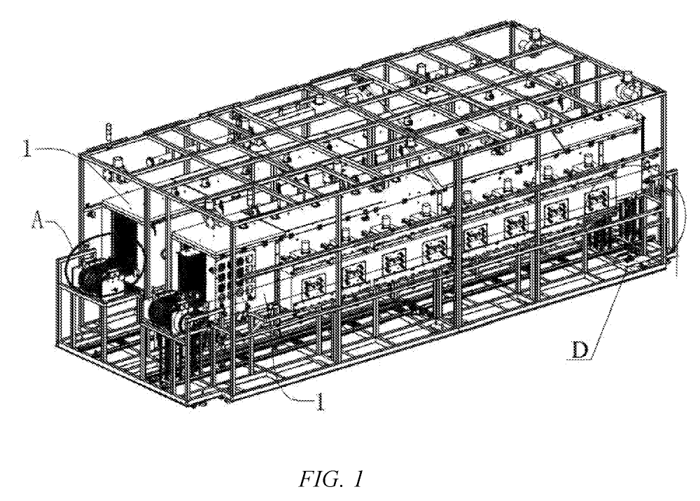

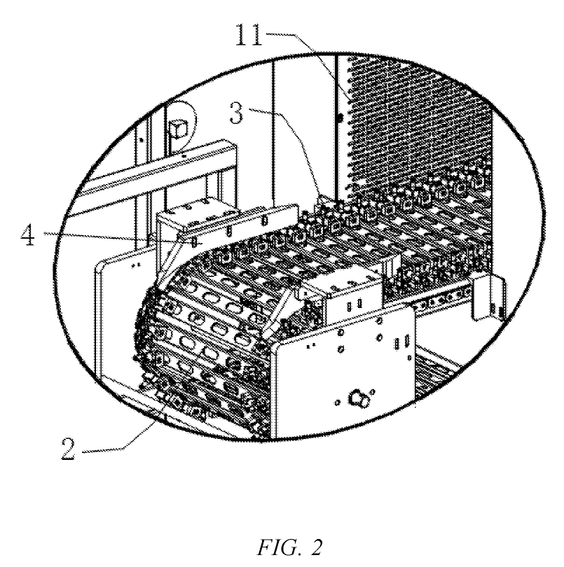

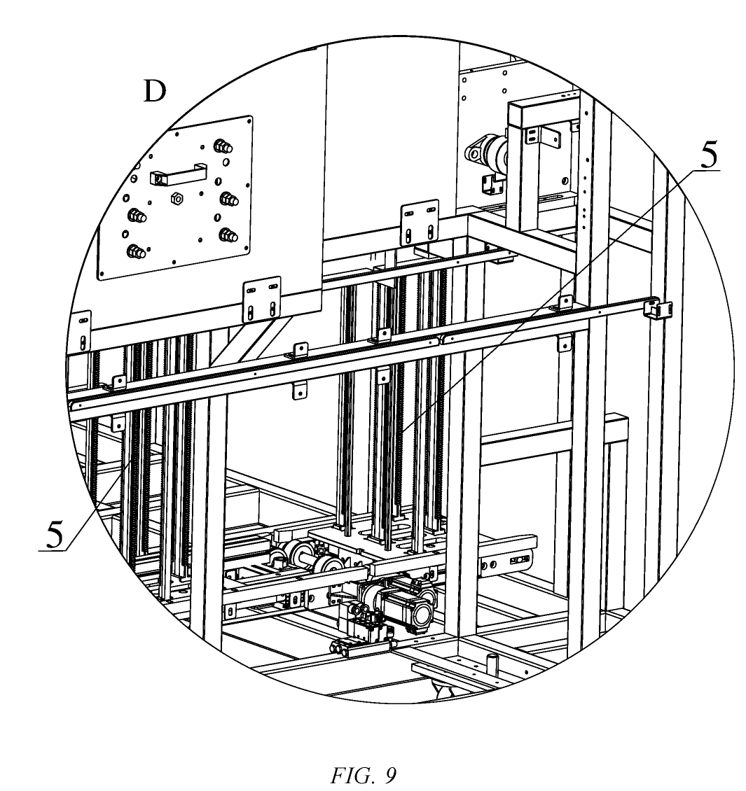

Referring to FIGS. 1-3, and 9, a drying device with stable conveyance includes at least one drying furnace disposed side by side. Each drying furnace includes a furnace body 1, a conveyance mechanism 2, a locking mechanism 3, and a unlocking mechanism 4. The furnace body 1 is provided with a product channel 11. One end of the product channel 11 is a product inlet, and the other end of the product channel 11 is a product outlet. The conveyance mechanism 2 extends through the product channel 11, and is used for conveying a product in the product channel 11, and the conveyance mechanism 2 is provided with a carrier 5 for loading the product. The locking mechanism 3 is arranged on the conveyance mechanism 2, and includes a plurality of locking portions arranged on the conveyance mechanism 2 in a product conveyance direction. The locking portions are used for locking the carrier 5 on the conveyance mechanism 2. The unlocking mechanism 4 is at least arranged at the product outlet, and is used for releasing the locking of the carrier 5 by the locking mechanism 3.

In the process of conveying the carrier 5 loaded with the product along with the conveyance mechanism 2 along the product channel 11, the carrier 5 can be locked on the conveyance mechanism 2 through the locking portions of the locking mechanism 3, to improve the stability of the carrier 5 on the conveyance mechanism 2, thereby suppressing tilting or vibration of the carrier 5 in the conveyance process. The unlocking mechanism 4 is disposed at the product outlet to release the locking between the carrier 5 and the conveyance mechanism 2, thereby facilitating the removal of the carrier 5 from the conveyance mechanism 2.

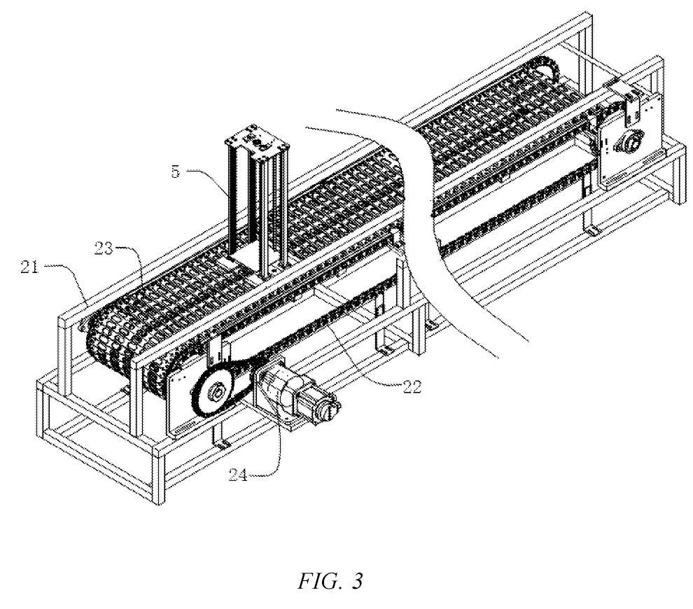

In some embodiments, referring to FIG. 3, the conveyance mechanism 2 includes a drive roller and a driven roller mounted on a conveyance rack 21. The driven roller and the drive roller are wrapped together with two closed-loop chains 22 arranged side by side. A plurality of support plates 23 used for bearing the carrier 5 are uniformly arranged between the two closed-loop chains 22 in the product conveyance direction. In addition, the conveyance rack 21 is provided with a conveyance drive assembly 24 connected to the drive roller. When the conveyance drive assembly 24 is started, the drive roller rotates along, and drives the two closed-loop chains 22 to perform synchronous transmission, and the driven roller rotates immediately. In this case, the carrier located on the support plate 23 is conveyed immediately along the product channel 11.

Furthermore, the conveyance drive assembly 24 includes a drive motor mounted on the conveyance rack 21, and the drive motor is connected to the drive roller by a synchronous chain assembly, thereby improving the operational stability of the drive roller.

It should be noted that the structure of the conveyance mechanism 2 may use existing technologies, provided that the conveyance of the carrier 5 and the product along the product channel 11 is achieved. The locking mechanism 3 and the unlocking mechanism 4 are described below in detail.

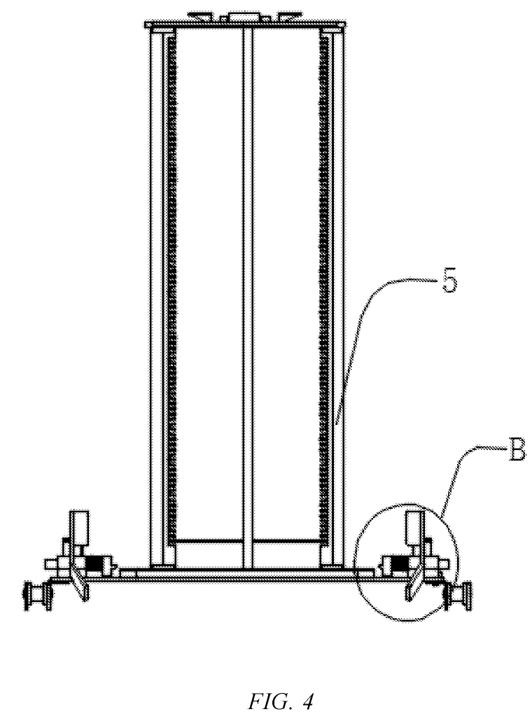

In some embodiments, referring to FIGS. 4 to 7, each of the locking portions includes locking assemblies symmetrically disposed on two sides of the carrier 5 in a direction perpendicular to the product conveyance direction. Each of the locking assemblies includes a locking block 31, an elastic member 32, and a movable member 33. The movable member 33 is movable toward or away from the carrier 5 along the conveyance mechanism 2. The locking block 31 is connected to a side of the movable member 33 that faces the carrier 5. The elastic member 32 is located at an end of the locking block 31 that is away from the carrier 5, one end of the elastic member 32 abuts against the locking block 31, and the other end of the elastic member 32 is fixed on the conveyance mechanism 2. In addition, when the locking block 31 abuts against the carrier 5, the elastic member 32 is in a compressed state.

Because the locking portion is arranged on the conveyance mechanism 2, the locking portion can be synchronously conveyed along with the product and the carrier 5 in the process of conveying the product and the carrier 5. In the locking portion, in the direction perpendicular to the product conveyance direction, through the cooperation of the two locking assemblies, the two locking blocks 31 are enabled to simultaneously to move toward or away from the carrier 5, thereby achieving the limiting and locking or unlocking of the carrier 5 during conveyance. The elastic members 32 in a compressed state are then disposed to enable the locking blocks 31 to elastically press against the carrier 5, thereby ensuring the locking of the carrier 5 and avoiding damage to the surface of the carrier 5 due to rigid pressing.

It should be noted that in this embodiment, the movement toward or away from the carrier is movement toward or away from the carrier in the direction perpendicular to the product conveyance direction. The number of the locking portions may be set the same as the number of the support plates 23, and the locking portions are disposed on the support plate 23 in a one-to-one correspondence. Alternatively, the number of the support plates 23 may be multiple times greater than the number of the locking portions, and the plurality locking portions are uniformly disposed at intervals on the plurality of support plates 23. Regardless of the setting of the number of the locking portions, it needs to be ensured that a spacing between two adjacent locking portions is less than the size of the carrier 5 in the product conveyance direction, so that when the carrier 5 is placed on the conveyance mechanism 2, at least one locking portion can lock the carrier 5.

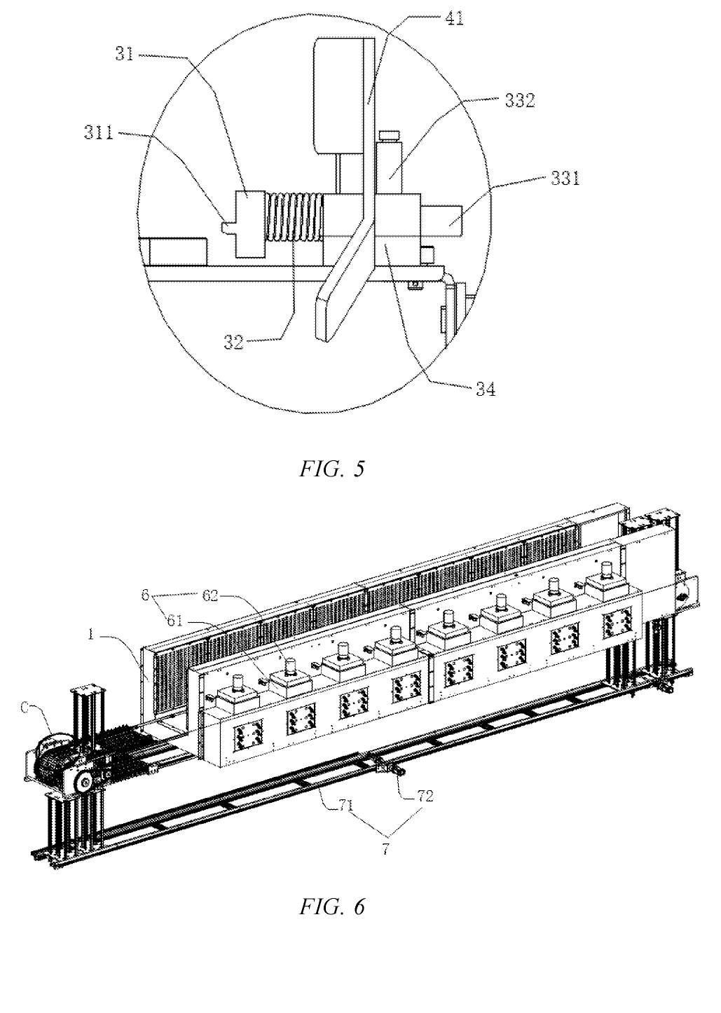

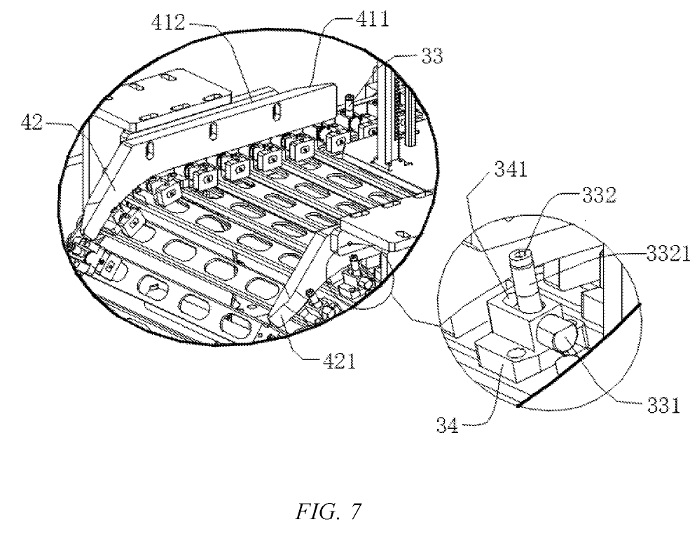

In some embodiments, referring to FIGS. 5 and 7, the locking assembly further includes a mounting base 34. The mounting base 34 is fixedly mounted on the support plate 23, and a guide slot is opened on the mounting base and arranged in the direction perpendicular to the product conveyance direction. The movable member 33 includes a pull rod 331 passing through the guide slot, and an end of the pull rod 331 (in the direction perpendicular to the product conveyance direction) that faces the carrier 5 is connected to the locking block 31. The locking block 31 is suspended, and an end of the locking block 31 that is away from the pull rod 331 is used for abutting against the carrier 5.

The mounting base 34 and the guide slot are disposed to guide the movement direction of the pull rod 331, thereby ensuring the accuracy of the locking direction of the locking block 31. The locking block 31 is suspended to reduce the contact between the locking block 31 and the support plate 23 in a movement process, thereby reducing movement resistance.

Furthermore, referring to FIG. 5, the elastic member 32 includes a spring sleeved over the pull rod 331, one end of the spring abuts against the locking block 31, and the other end of the spring abuts against the mounting base 34. Because the mounting base 34 is fixedly connected to the conveyance mechanism 2, when an external force pulls the pull rod 331 to move away from the carrier 5, the locking block 31 can move synchronously, thereby compressing the spring. When the external force is removed, the locking block 31 can move toward the carrier 5 under the reset action of the spring, thereby achieving the locking of the carrier 5.

To ensure that the spring remains in a compressed state, it is necessary to limit the movement ranges of the pull rod 331 and the locking block 31. In some embodiments, referring to FIG. 7, an obround slot 341 in communication with the guide slot is opened on an upper end of the mounting base 34. A vertical rod 332 is fixedly disposed on the pull rod 331, and the vertical rod can pass through the obround slot. When the vertical rod 332 moves in the obround slot 341, the spring remains in a compressed state. In addition, when the vertical rod 332 moves to an end of the obround slot 341 that is close to the carrier 5, the locking block 31 can lock the carrier 5. When the vertical rod 332 moves to an end of the obround slot 341 that is away from the carrier 5, the locking block 31 cannot lock the carrier 5. The obround slot 341 is provided to limit the movement range of the vertical rod 332, thereby indirectly limiting the movement range of the pull rod 331 and the locking block 31.

The locking block 31 locks the carrier 5 from a side surface of the carrier 5, which can effectively suppress the lateral tipping of the carrier 5, but exhibits poor locking against forward or rearward tilting of the carrier 5. Based on this, to enhance the locking of the carrier 5, in some embodiments, a locking protrusion 311 is provided on a side of the locking block 31 that faces the carrier 5. When the locking block 31 abuts against the side surface of the carrier 5, a lower end surface of the locking protrusion 311 can also abut against the carrier 5, so that the carrier 5 can be restricted in a vertical direction, to cooperate with the locking block 31 to form multi-position locking for the carrier 5, thereby enhancing the locking stability of the carrier 5.

Furthermore, the lower end surface of the locking protrusion 311 is a downward-arching arc-shaped surface, to enable the contact between the locking protrusion 311 and the carrier 5 to be line contact, thereby minimizing the contact friction between the locking protrusion 311 and the carrier 5.

In some embodiments, referring to FIGS. 5 and 7, the unlocking mechanism 4 includes unlocking assemblies symmetrically disposed on the conveyance mechanism 2 in the direction perpendicular to the product conveyance direction. Each of the unlocking assemblies includes a plate body 41 arranged in the product conveyance direction. The plate body 41 is fixedly connected to the conveyance rack 21, and is suspended above the support plate 23. An unlocking surface capable of pressing against the vertical rod 332 is provided on a side of the plate body 41 that is away from the carrier 5. Specifically, the unlocking surface includes an unlocking inclined surface 411 and a pressing flat surface 412 that are continuously disposed in the product conveyance direction, the unlocking inclined surface 411 is located at an end of the pressing flat surface 412 that is away from the product outlet, and the unlocking inclined surface 411 gradually tilts away from the carrier 5 from an end that is far away from the pressing flat surface 412 to an end that is close to the pressing flat surface 412, to enable the vertical rod 332 to drive the locking block 31 to move away from the carrier 5 when the vertical rod 332 moves along the unlocking inclined surface 411 toward the pressing flat surface 412.

During actual arrangement, the height of a lower end surface of the plate body 41 should be greater than the height of the upper end surface of the mounting base 34, thereby ensuring that when the vertical rod 332 moves along an unlocking surface of the plate body 41, the mounting base 34 can pass through from below the plate body 41. Additionally, to ensure that the vertical rod 332 can smoothly abut against the unlocking inclined surface 411, and an end of the unlocking inclined surface 411 that is away from the pressing flat surface 412 should be disposed closer to the carrier 5 than the vertical rod 332 in a locked state (in the locked state, the locking block 31 is pressed against the carrier 5, and the vertical rod 332 is located at the end of the obround slot 341 that is close to the carrier 5). When the vertical rod 332 in the locked state moves to the unlocking assembly, the vertical rod 332 can directly abut against the unlocking inclined surface 411, and in a process of the mounting base 34 moving along with the conveyance mechanism 2, the vertical rod 332 can move along the unlocking inclined surface 411, thereby driving the locking block 31 to move away from the carrier 5. When the vertical rod 332 moves to a boundary between the unlocking inclined surface 411 and the pressing flat surface 412, the vertical rod 332 can moves to the end of the obround slot 341 that is away from the carrier 5. In this case, the locking block 31 no longer abuts against the carrier 5, and the carrier 5 is in an unlocked state.

The pressing flat surface 412 remains a flat surface in the product conveyance direction. After the vertical rod 332 moves to the pressing flat surface 412 along the unlocking inclined surface 411, the vertical rod 332 remains pressed against the pressing flat surface 412, thereby ensuring that the locking block 31 remains in a state of not abutting against the carrier 5.

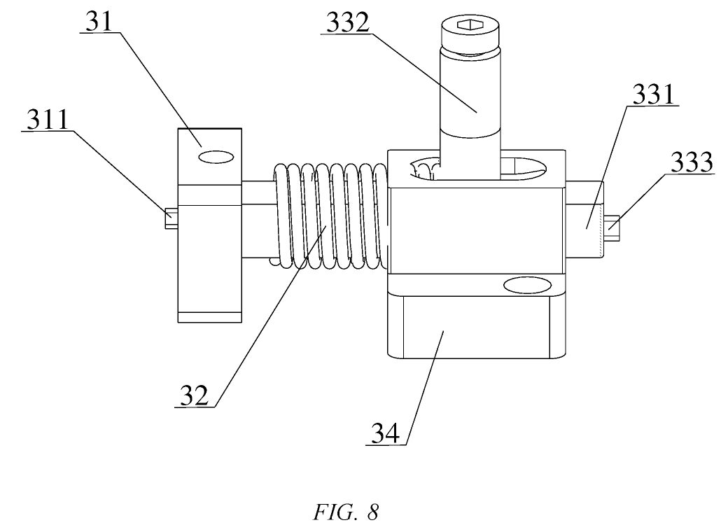

Referring to FIG. 8, in some embodiments, the plate body 41 is no longer provided with the unlocking inclined surface 411, and the plate body 41 is made of a magnetic material to make the plate body 41 magnetic. An end of the pull rod 331 that is close to plate body 41 is connected to a magnet 333. When the pull rod 331 moves to an attraction position of the plate body 41, the plate body 41 can attract the magnet 333 to enable the pull rod 331 to move toward the plate body 41 until the magnet 333 is pressed against the plate body 41. In this case, the locking block 31 locks the carrier 5. When the pull rod 331 is disengaged from the attraction position of the plate body 41, the plate body 41 no longer attracts the magnet 333. The locking block 31 is reset through the elastic member 32, to enable the carrier 5 to be in an unlocked state. Both the plate body 41 and the magnet 333 are made of magnetic materials, so that the plate body 41 has a simpler overall structure, and is easier to process. Preferably, the elastic member 32 is disposed to make an attraction force between the magnet 333 and the plate body 41 balance with the elastic force of the elastic member 32, so that while the magnet 333 does not need to contact the plate body 41, the locking block 31 can also lock the carrier 5, to avoid the sliding friction between the magnet 333 and the plate body 41, thereby extending the service life of the magnet 333 and the plate body 41.

Furthermore, referring to FIG. 7, the vertical rod 332 includes a rod body integrally formed with the pull rod 331. A rotatable protective cover 3321 is sleeved over the rod body. The outer diameter of the protective cover 3321 is slightly greater than the outer diameter of the rod body. When the vertical rod 332 reaches the unlocking surface, the protective cover 3321 can abut against the unlocking surface. Through the cooperation between the protective cover 3321 and the rod body, the friction between the vertical rod 332 and the unlocking surface can be adjusted to rolling friction, thereby reducing the frictional resistance between the vertical rod 332 and the unlocking surface.

Because the conveyance mechanism 2 has a closed-loop form, in a transmission process of the closed-loop chain 22, the support plate 23 and the locking portion that move to the product outlet can recirculate to the product inlet. In this case, the locking portion is no longer subjected to the action of the unlocking mechanism at the product outlet, and the locking block 31 can be reset to a locked state under the action of the spring. To avoid the violent collision of the vertical rod 332 in the obround slot 341 due to excessively quick resetting of the locking block 31, in some embodiments, an end of the plate body 41 that is away from the unlocking inclined surface 411 is bent downward to form a bent plate 42 with a shape matching the conveyance mechanism 2 at the product outlet. A guide surface is provided on a side of the bent plate 42 that is away from the carrier 5. The guide surface includes a guide flat surface and a guide inclined surface 421 that are continuously arranged. The guide flat surface is located between the guide inclined surface 421 and the pressing flat surface 412, the guide flat surface and the pressing flat surface 412 are located in a same plane. The guide inclined surface 421 gradually tilts toward the carrier 5 from an end that is close to the guide flat surface to an end that is far away from the guide flat surface.

When the vertical rod 332 moves toward the bent plate 42 along the plate body 41, the vertical rod 332 can sequentially enter the guide flat surface and the guide inclined surface 421 along the pressing flat surface 412. When the vertical rod 332 is pressed against the guide inclined surface 421, under the reset action of the spring and the guide action of the guide inclined surface 421, the locking block 31 can gradually move toward the carrier 5, thereby buffering the reset action of the locking assembly through the arrangement of the bent plate 42.

In some embodiments, the unlocking mechanism 4 may alternatively be disposed at the product inlet. However, the arrangement direction is different from the product inlet. At the product inlet, along with the conveyance of the conveyance mechanism 2, the vertical rod 332 first contacts the pressing flat surface 412 of the unlocking mechanism 4, and then contacts the unlocking inclined surface 411 of the unlocking mechanism 4. At the product outlet, the vertical rod 332 first contacts the unlocking inclined surface 411 of the unlocking mechanism 4 and then contacts the pressing flat surface 412 of the unlocking mechanism 4.

In some embodiments, referring to FIG. 6, the furnace body 1 is provided with a drying zone and a cooling zone in sequence in the product conveyance direction, a heating module 6 used for heating the product channel 11 is provided in the drying zone, and the heating module 6 is a single-pass heating module or a dual-cycle heating module. The heating module 6 is disposed to heat and dry the product in the product channel 11.

For the single-pass heating module, a single heating chamber 61 with a built-in heating member is disposed on a side of the furnace body 1, and the circulation of airflow between a heating chamber 51 and the product channel 11 is achieved through a circulating fan 62. For the dual-cycle heating module, a heating chambers 61 with a built-in heating member is disposed on each of two sides of the furnace body 1, and the circulation of airflow between each heating chamber 61 and the product channel 11 is achieved through an independent circulating fan 62.

When the product is transferred to a next process stage from the product outlet, an empty carrier 5 remains on the conveyance mechanism 2. To recycle or temporarily store the empty carrier 5, in some embodiments, a carrier recirculation mechanism 7 used for conveying the carrier 5 is provided below the furnace body 1. Specifically, the carrier recirculation mechanism 7 includes a carrier rack 71. The carrier rack 71 is arranged in the product conveyance direction. Two ends of the carrier rack 71 respectively extend below the product inlet and the product outlet of the product channel 11. In addition, a linear conveyance module 72 is disposed on the carrier rack 71.

During use, when the product is transferred to a next process stage from the product outlet, the empty carrier 5 remains at the product outlet. In this case, the empty carrier 5 is placed on the linear conveyance module 72 of the carrier rack 71, thereby achieving a temporary storage operation on the empty carrier 5. When the carrier 5 needs to be used at the product inlet, the empty carrier 5 may recirculate to the side of the product inlet through the linear conveyance module 72.

Because a height difference exists between the carrier recirculation mechanism 7 and the conveyance mechanism 2, in some embodiments, a lifting mechanism used for lifting the carrier 5 onto the conveyance mechanism 2 is provided between the conveyance mechanism 2 that is close to the product inlet and the carrier recirculation mechanism 7.

When the product enters a next process stage from the product outlet, the carrier recirculation mechanism 7 is disposed to enable the carrier 5 at the product outlet to recirculate to the product inlet, and then the lifting mechanism lifts the carrier 5 on the carrier recirculation mechanism 7 onto the conveyance mechanism 2, thereby facilitating the loading of a next product.

The foregoing embodiments are only used to describe the technical concept and characteristics of the present invention, and are intended to enable a person skilled in the art to understand the content of the present invention and achieve implementation, but shall not be used to limit the protection scope of the present invention. Any equivalent variations or modifications made according to the spirit and essence of the present invention shall fall within the protection scope of the present invention.

What is claimed is:

1. A drying device with stable conveyance, comprising at least one drying furnace arranged side by side, wherein each drying furnace comprises:
a furnace body, provided with a product channel, wherein one end of the product channel is a product inlet, and the other end of the product channel is a product outlet;
a conveyance mechanism, used for conveying a product in the product channel, wherein the conveyance mechanism extends through the product channel, and is provided with a carrier for loading the product;
a locking mechanism, arranged on the conveyance mechanism, and comprising a plurality of locking portions arranged on the conveyance mechanism in a product conveyance direction, wherein the locking portions are used for locking the carrier on the conveyance mechanism; and
an unlocking mechanism, at least arranged at the product outlet, and used for releasing the locking of the carrier by the locking mechanism.

2. The drying device according to claim 1, wherein each of the locking portions comprises locking assemblies symmetrically disposed on two sides of the carrier in a direction perpendicular to the product conveyance direction, each of the locking assemblies comprises a locking block, an elastic member, and a movable member, the movable member is movable toward or away from the carrier along the conveyance mechanism, and the locking block is connected to a side of the movable member that faces the carrier; the elastic member is located at an end of the locking block that is away from the carrier, one end of the elastic member abuts against the locking block, and the other end of the elastic member is fixed on the conveyance mechanism; and when the locking block abuts against the carrier, the elastic member is in a compressed state.

3. The drying device according to claim 2, wherein the locking assembly further comprises a mounting base, and the mounting base is fixedly connected to the conveyance mechanism, and a guide slot is opened on the mounting base and extends through the mounting base; the movable member comprises a pull rod passing through the guide slot, and an end of the pull rod that faces the carrier is connected to the locking block; and the elastic member comprises a spring sleeved over the pull rod, one end of the spring abuts against the locking block, and the other end of the spring abuts against the mounting base.

4. The drying device according to claim 3, wherein an obround slot in communication with the guide slot is opened on an upper end of the mounting base; and a vertical rod is fixedly disposed on the pull rod, and the vertical rod can pass through the obround slot.

5. The drying device according to claim 2, wherein a locking protrusion is provided on a side of the locking block that faces the carrier; when the locking block abuts against the carrier, a lower end surface of the locking protrusion also abuts against the carrier; and the lower end surface of the locking protrusion is configured as a downward-arching arc-shaped surface.

6. The drying device according to claim 4, wherein the unlocking mechanism comprises unlocking assemblies symmetrically disposed on the conveyance mechanism in the direction perpendicular to the product conveyance direction, each of the unlocking assemblies comprises a plate body arranged in the product conveyance direction, the plate body is suspended above the conveyance mechanism, and an unlocking surface capable of pressing against the movable member is provided on a side of the plate body that is away from the carrier; and when the carrier moves to the unlocking mechanism, the movable member is movable away from the carrier under the action of an unlocking surface, to detach the locking block from the carrier.

7. The drying device according to claim 6, wherein the unlocking surface comprises an unlocking inclined surface and a pressing flat surface that are continuously disposed in the product conveyance direction, the unlocking inclined surface gradually tilts away from the carrier from an end that is far away from the pressing flat surface to an end that is close to the pressing flat surface, to enable the vertical rod to drive the locking block to move away from the carrier when the vertical rod moves along the unlocking inclined surface toward a pressing flat surface.

8. The drying device according to claim 7, wherein an end of the plate body that is away from the unlocking inclined surface is bent downward to form a bent plate, a guide surface is provided on a side of the bent plate that is away from the carrier, the guide surface comprises a guide flat surface and a guide inclined surface that are continuously arranged; and the guide flat surface is located between the guide inclined surface and the pressing flat surface, the guide flat surface and the pressing flat surface are located in a same plane, and the guide inclined surface gradually tilts toward the carrier from an end that is close to the guide flat surface to an end that is far away from the guide flat surface.

9. The drying device according to claim 1, wherein the furnace body is provided with a drying zone and a cooling zone in sequence in the product conveyance direction, a heating module used for heating the product channel is provided in the drying zone, and the heating module is a single-pass heating module or a dual-cycle heating module.

10. The drying device according to claim 1, wherein a carrier recirculation mechanism used for conveying the carrier is provided below the furnace body, and a lifting mechanism used for lifting the carrier onto the conveyance mechanism is provided between the conveyance mechanism that is close to the product inlet and the carrier recirculation mechanism.

11. The drying device according to claim 6, wherein the plate body is magnetic, a magnet is connected to an end of the pull rod that is close to the plate body, and the plate body can attract the magnet.
